(19) United States
(12) Patent Application Publication
(10) Pub. No.: US 2019/0319709 A1
(43) Pub. Date: Oct. 17, 2019

(54) METHOD FOR MANAGING OPTICAL NETWORK UNIT ONU, APPARATUS, AND SYSTEM

(71) Applicant: HUAWEI TECHNOLOGIES CO., LTD., Shenzhen (CN)

(72) Inventors: Gang ZHENG, Dongguan (CN); Xifeng WAN, Dongguan (CN); Wei LIN, Shenzhen (CN)

(21) Appl. No.: 16/455,426

(22) Filed: Jun. 27, 2019

Related U.S. Application Data
(63) Continuation of application No. PCT/CN2016/113858, filed on Dec. 30, 2016.

(51) Int. Cl. H04B 10/27; H04B 10/40

(52) U.S. Cl. CPC H04B 10/27; H04B 10/40

(57) ABSTRACT

A method for managing an optical network unit (ONU), an apparatus, and a system are disclosed. A message for obtaining a management mode supported by an ONU is sent, where the management mode supported by the ONU includes one or more of an OMCI mode, an OAM management mode, a NETCONF management mode, a TR069 management mode, and a SNMP management mode; a management mode sent by the ONU is received; a management mode to be used for the ONU is selected based on the management mode supported by the ONU, and is sent to the ONU. In this way, a plurality of existing management mechanisms of the ONU are compatible with each other, management of the ONU is simplified, and efficiency of managing the ONU is improved.

### CROSS-REFERENCE TO RELATED APPLICATION

This application is a continuation of International Patent Application No. PCT/CN2016/113858, filed on Dec. 30, 2016, the disclosure of which is hereby incorporated by reference in its entirety.

### TECHNICAL FIELD

The disclosure relates to the optical communications field, and in particular, to a method for managing an optical network unit (ONU), an apparatus, and a system.

### BACKGROUND

A passive optical network (PON) is a point-to-multipoint network topology structure, and usually includes an optical line terminal (OLT) located at a central office, a plurality of optical network units (ONU) located at a user end, and an optical distribution network (ODN) located between the OLT and the plurality of ONUs.

In a PON system, an ONT is remotely managed and maintained by using physical layer operation, administration and maintenance (PLOAM) and optical network terminal management and control interface (OMCI) mechanisms in a gigabit-capable passive optical network (GPON) system, and an optical network terminal (ONT) is remotely managed and maintained by using Multi-Point Control Protocol (MPCP) and operation, administration and maintenance (OAM) mechanisms in an Ethernet passive optical network (EPON) system. With development of technologies, a standardization organization defines a new management mechanism, namely network configuration protocol (NETCONF)/YANG, to manage an ONU device. However, an existing ONU device cannot support all the foregoing management mechanisms. Consequently, management of the ONU device is complex.

### SUMMARY

To support a plurality of existing management mechanisms for an ONU, simplify management of the ONU, and improve efficiency of managing the ONU, the following technical solutions are provided.

In a first design solution, a method for managing an optical network unit (ONU) is provided. The method includes:

sending a message to the ONU, to obtain a management mode supported by the ONU, where the management mode supported by the ONU includes one or more of an OMCI mode, an OAM management mode, a NETCONF management mode, a TR069 management mode, or a SNMP management mode; receiving a management mode sent by the ONU; and selecting, based on the management mode supported by the ONU, a management mode to be used for the ONU, and sending the selected management mode to the ONU.

Based on a possible design in the first design solution, the method further includes:

when the management mode supported by the ONU is the NETCONF management mode, delivering a management channel creation message to the ONU, to instruct the ONU to create a management channel to be used in the management mode.

In another possible design, the delivering a management channel creation message to the ONU, to instruct the ONU to create a management channel to be used in the management mode specifically includes:

sending a message for obtaining channel configuration information of the management channel supported by the ONU;

receiving the channel configuration information returned by the ONU, where the channel configuration information includes information about one or more of a static configuration Internet protocol (IP), a dynamic host configuration protocol (DHCP), or a point-to-point protocol over Ethernet (PPPoE); and

selecting, based on the channel configuration information returned by the ONU, a channel configuration used by the ONU, and delivering management channel creation information to the ONU, to instruct the ONU to create the management channel to be used in the management mode, where the management channel creation information includes management configuration information of the ONU and the channel configuration that is used by the ONU and determined by an OLT.

In a third possible design, the method further includes: receiving a management channel completion message returned by the ONU; and exchanging data with the ONU in the NETCONF management mode.

In this design solution, the method for managing an ONU is provided. The ONU reports its supported management mode, and the OLT selects, based on the management mode supported by the ONU, the management mode to be used for the ONU, and sends the management mode to the ONU. In the method, the management mode of the ONU is negotiated between the OLT and the ONU. In this way, an existing system can support a plurality of management mechanisms of the ONU, management of the ONU is simplified, and efficiency of managing the ONU is improved.

In a second design solution, a network device is provided. The network device includes:

a transceiver, configured to: send a message for obtaining a management mode supported by an optical network unit (ONU), where the management mode supported by the ONU includes one or more of an optical network unit management and control interface OMCI mode, an operation, administration, and maintenance OAM management mode, a network configuration protocol NETCONF mode, a technical report 069 (TR069) mode, or a simple network management (SNMP) mode; receive a management mode sent by the ONU; and send a selected management mode to the ONU; and

a processor, configured to: select a management mode for the ONU based on the management mode supported by the ONU; and send the selected management mode to the ONU by using the transceiver.

Based on the foregoing related solution, in a possible design, the processor is further configured to:

when the management mode supported by the ONU is the NETCONF management mode, instruct the transceiver to send a management channel creation message to the ONU, to instruct the ONU to create a management channel to be used in the management mode.

Based on the foregoing related solution, in another possible design, the processor is specifically configured to: instruct the transceiver to send, to the ONU, a message for obtaining channel configuration information of the management channel supported by the ONU; select, based on the channel configuration information that is supported by the ONU and received by the transceiver, a channel configuration used by the ONU; and deliver management channel creation information to the ONU, to instruct the ONU to create, based on the management channel information, the management channel to be used in the management mode, where the management channel creation information includes management configuration information of the ONU and the channel configuration that is used by the ONU and determined by an OLT; and

the transceiver is configured to: send, to the ONU as instructed by the processor, the message for obtaining the channel configuration information of the management channel supported by the ONU, and receive the channel configuration information returned by the ONU, where the channel configuration information includes information about one or more of a static configuration Internet protocol (IP), a dynamic host configuration protocol (DHCP), or a point-to-point protocol over Ethernet (PPPoE).

Based on the foregoing related solution, in still another possible design, the transceiver is further configured to receive a management channel completion message returned by the ONU; and

the processor is further configured to exchange data with the ONU on the created management channel in the NETCONF management mode.

In this design solution, the network device is provided. The OLT receives the management mode that is supported by the ONU and reported by the ONU, selects, based on the management mode supported by the ONU, the management mode to be used for the ONU, and sends the management mode to the ONU. The management mode of the ONU is negotiated between the OLT and the ONU. In this way, an existing system can support a plurality of management mechanisms of the ONU, management of the ONU is simplified, and efficiency of managing the ONU is improved.

In a third design solution, an optical line terminal is provided, including the network device according to the second design solution.

In a fourth design solution, an optical line terminal is provided. The optical line terminal includes a network device. The OLT receives a management mode that is supported by an ONU and reported by the ONU, selects, based on the management mode supported by the ONU, a management mode to be used for the ONU, and sends the management mode to the ONU. In the method, the management mode of the ONU is negotiated between the OLT and the ONU. In this way, an existing system can support a plurality of management mechanisms of the ONU, management of the ONU is simplified, and management efficiency of the ONU is improved.

In a fifth design solution, a passive optical network (PON) system is provided. The PON system includes an optical line terminal (OLT) and an optical network unit (ONU), the OLT is connected to the ONU by using an optical distribution network (ODN), and the OLT includes the network device according to the second design solution.

In a sixth design solution, a data communications system is provided. The data communications system includes an optical line terminal (OLT), an optical network unit, and a controller, the controller is connected to each ONU by using the OLT, and the OLT includes the network device according to the second design solution.

### BRIEF DESCRIPTION OF DRAWINGS

FIG. 1 is a system architecture diagram of a data communications system according to an embodiment of the disclosure;

FIG. 2 is a schematic flowchart of a method for managing an optical network unit (ONU) according to an embodiment of the disclosure;

FIG. 3a to FIG. 3c are schematic structural diagrams of various PLOAM messages according to an embodiment of the disclosure;

FIG. 4a to FIG. 4d are schematic structural diagrams of various MPCP messages according to an embodiment of the disclosure;

FIG. 5a to FIG. 5c are schematic structural diagrams of another PLOAM message according to an embodiment of the disclosure;

FIG. 6a to FIG. 6c are schematic structural diagrams of another MPCP message according to an embodiment of the disclosure;

FIG. 7 is a schematic structural diagram of a first network device according to an embodiment of the disclosure; and

FIG. 8 is a schematic structural diagram of a second network device according to an embodiment of the disclosure.

### DESCRIPTION OF EMBODIMENTS

To make the objectives, technical solutions, and advantages of the disclosure clearer, the following further describes the implementations of the disclosure in detail with reference to the accompanying drawings.

In this specification, “a plurality of” refers to two or more than two. The term “and/or” describes an association relationship for describing associated objects and represents that three relationships may exist. For example, A and/or B may represent the following three cases: Only A exists, both A and B exist, and only B exists. The character “/” generally indicates an “or” relationship between the associated objects.

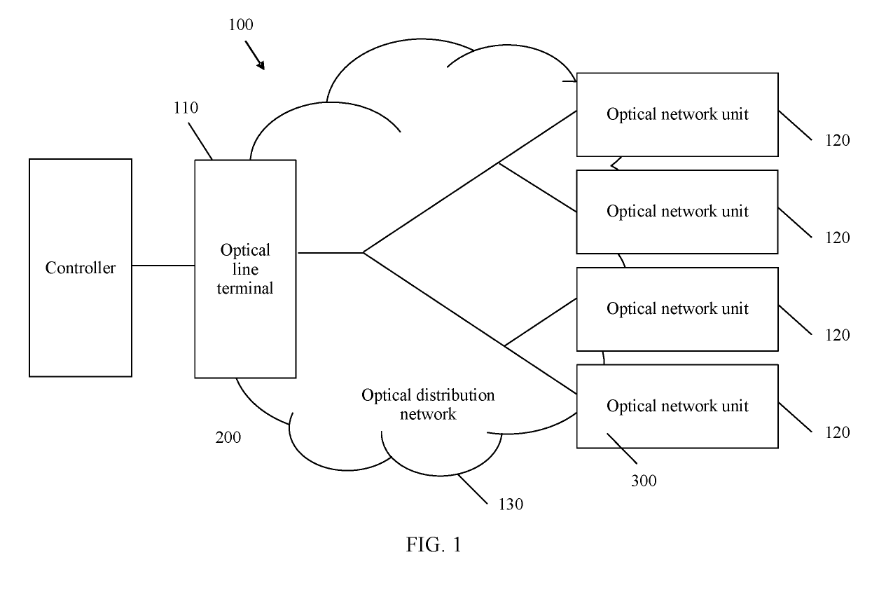

Referring to FIG. 1, a data communication system 100 includes at least one optical line terminal (OLT) 110, a plurality of optical network units (ONU) 120, and one optical distribution network (ODN) 130. The optical line terminal 110 is connected to the plurality of optical network units 120 in a point-to-multipoint manner by using the optical distribution network 130. A TDM mechanism, a WDM mechanism, or a hybrid TDM/WDM mechanism may be used for communication between the optical line terminal 110 and the optical network units 120. Directions from the optical line terminal 110 to the optical network units 120 are defined as downstream directions, and directions from the optical network units 120 to the optical line terminal 110 are defined as upstream directions.

The data communication system further includes a controller. The controller may be connected to the optical line terminal (OLT) 110, and communicate data with the ONUs 120 by using the OLT 110, or may transparently transmit data to the ONUs 120 by using the OLT 110.

When the ONU supports a network configuration protocol (NETCONF), the OLT creates a management channel for the ONU by using an extended PLOAM message, for example, creates an Internet protocol (IP) management channel. After the management channel is created, the ONU encapsulates data into a NETCONF message and transmits the data to the OLT by using the created IP management channel, and the OLT sends the NETCONF message to the controller; or the OLT receives a NETCONF message from the controller, and forwards the NETCONF message to the ONU on the IP channel created between the OLT and the ONU.

The NETCONF provides a network device management mechanism. A customer may use the mechanism to add, modify, and delete a configuration of a network device, and obtain configuration and state information of the network device. With the NETCONF, the network device may provide a set of complete and standard APIs (Application Programming Interfaces); and an application program may directly use these APIs to deliver a configuration to the network device and obtain a configuration from the network device.

In the NETCONF, an RPC mechanism is used for communication interaction between a client and a server. To interact with the server, the client needs to successfully set up a secure and connection-oriented session to the server. The client sends an RPC request to the server, and after processing a customer request, the server sends a response message to the client. Both the RPC request of the client and the response message of the server are encoded in XML, and message content is fully described in XML DTDs or XML schemas, so that both communication parties can recognize syntax constraints.

For a detailed definition of NETCONF, refer to IETF RFC 6241, RFC 5277, and RFC 6536 standards. In the NETCONF, all messages such as configuration data Config Data and notification data Notification Data may be modeled by using a YANG model. A YANG model file may be converted into an XML file in a corresponding format by using a tool and is ultimately encapsulated into a NETCONF message. For a detailed definition of YANG, refer to IETF RFC 6020 and RFC 6991 standards. Details are not described herein. An Internet protocol (IP) channel is created between the ONU and the controller as a management channel, to transmit data supported in the NETCONF.

A specific format of the NETCONF message includes: a destination MAC, a source MAC, an Ethernet type, a TCP header, an RPC header, data, and an FCS. When the Ethernet type is 0x0800, the Ethernet type indicates an IP packet.

IP header: A header of an IP packet. When a protocol type in the IP header is TCP, it indicates that the IP header is followed by a TCP packet.

TCP header: A header of a TCP (Transmission Control Protocol) message. The TCP header distinguishes between specific services by using port numbers.

RPC (Remote Procedure Call Protocol): A payload of the TCP message.

NF/C data: Execution of the NF/C Protocol.

FCS: Check field in an Ethernet packet.

When the ONU does not support the NETCONF, the OLT configures and manages the ONU by using the OMCI Protocol.

The controller may be integrated into the OLT or may be independent of the OLT.

When the controller is integrated into the OLT, if the ONU supports an NETCONF management mode, an NETCONF message is transmitted between the OLT integrated with the controller and the ONU by using an IP channel.

The passive optical network system 100 may be a communications network for distributing data between the optical line terminal 110 and the optical network units 120 without needing any active device. In a specific embodiment, data between the optical line terminal 110 and the optical network units 120 may be distributed by a passive optical device (for example, an optical splitter) in the optical distribution network 130. The passive optical network system 100 may be an asynchronous transfer mode passive optical network (ATM PON) system or a broadband passive optical network (BPON) system defined in the ITU-T G.983 standard, a gigabit-capable passive optical network (GPON) system defined in the ITU-T G.984 series standard, an Ethernet passive optical network (EPON) system, a wavelength division multiplexing passive optical network (WDM PON) system, or a next generation access passive optical network system (NGA PON system, for example, an XGPON system defined in the ITU-T G.987 series standard, a 10G-EPON system defined in the IEEE 802.3av standard, or a hybrid TDM/WDM PON system) defined in the IEEE 802.3ah standard. All content of the various passive optical network systems defined in the foregoing standards is incorporated herein by reference in its entirety.

The optical line terminal 110 is usually located at a central location (for example, a central office (CO)), and can manage all the plurality of optical network units 120. The optical line terminal 110 may serve as a medium between the optical network units 120 and an upper-layer network (not shown in the figure), to forward data received from the upper-layer network as downstream data to the optical network units 120, and forward upstream data received from the optical network units 120 to the upper-layer network. A specific structural configuration of the optical line terminal 110 may vary with a specific type of the passive optical network system 100. In an embodiment, the optical line terminal 110 may include a receiver and transmitter optical subassembly 200 and a data processing module (not shown in the figure). The receiver and transmitter optical subassembly 200 can convert downstream data processed by the data processing module, into a downstream optical signal; send, by using the optical distribution network 130, the downstream optical signal to the optical network units 120; receive an upstream optical signal sent by the optical network units 120 by using the optical distribution network 130; and convert the upstream data signal into an electrical signal, and provide the electrical signal for the data processing module for processing.

The optical network units 120 may be disposed at locations on a customer side (for example, customer premises) in a distributed manner. The optical network units 120 may be network devices configured for communication between the optical line terminal 110 and a customer. Specifically, the optical network units 120 may serve as media between the optical line terminal 110 and the customer. For example, the optical network units 120 may forward downstream data received from the optical line terminal 110 to the customer, and forward data received from the customer as upstream data to the optical line terminal 110. A specific structural configuration of the optical network units 120 may vary with a specific type of the passive optical network 100. In an embodiment, the optical network units 120 may include a receiver and transmitter optical subassembly 300. The receiver and transmitter optical subassembly 300 is configured to receive a downstream data signal sent by the optical line terminal 110 by using the optical distribution network 130, and send an upstream data signal to the optical line terminal 110 by using the optical distribution network 130. It should be understood that in the disclosure, structures of the optical network units 120 are similar to a structure of an optical network terminal (ONT). Therefore, in the solution provided in the disclosure, the optical network unit and the optical network terminal are interchangeable.

The optical distribution network 130 may be a data distribution system, and may include an optical fiber, an optical coupler, an optical multiplexer/demultiplexer, an optical splitter, and/or another device. In an embodiment, the optical fiber, the optical coupler, the optical multiplexer/demultiplexer, the optical splitter, and/or another device each may be a passive optical device. Specifically, the optical fiber, the optical coupler, the optical multiplexer/demultiplexer, the optical splitter, and/or another device each may be a device for distributing data signals between the optical line terminal 110 and the optical network units 120 without needing support of a power supply. In addition, in another embodiment, the optical distribution network 130 may further include one or more processing devices, for example, an optical amplifier, or a relay device. In a branch structure shown in FIG. 1, the optical distribution network 130 may specifically extend from the optical line terminal 110 to the plurality of optical network units 120, or may be configured as any other point-to-multipoint structure.

The receiver and transmitter optical subassembly 200 or 300 may be a pluggable receiver and transmitter optical subassembly that has optical signal transmitting and receiving and optical-to-electrical conversion functions and an OTDR testing function. The receiver and transmitter optical subassembly 200 in the optical line terminal 110 is used an example. The receiver and transmitter optical subassembly may include a transmitter optical module 210, a receiver optical module 220, and an OTDR testing module 230. The transmitter optical module 210 is configured to: deliver a downstream data signal to the optical network units 120 by using the optical distribution network 130; and when a fiber optic network and a PON device need to be detected, test a control signal by using an OTDR provided by the OTDR testing module 230, and modulate the signal tested by the OTDR, into a downstream data signal, and output the downstream data signal to the optical distribution network 130. The receiver optical module 220 is configured to: receive an upstream data signal transferred by the optical distribution network 130 from the optical network unit 120, convert the upstream data signal into an electrical signal through optical-to-electrical conversion, and forward the electrical signal to a control module or a data processing module (not shown in the figure) in the optical line terminal 110 for processing.

It should be noted that the PON system shown in FIG. 1 may be an EPON system or a GPON system, or may be a 10G-EPON or a 100G-EPON, or may be an XG-PON, an XGS-PON, or a TWDM-PON. This is not limited in this embodiment of the disclosure.

All methods for managing an ONU that are described below are applicable to the system in FIG. 1.

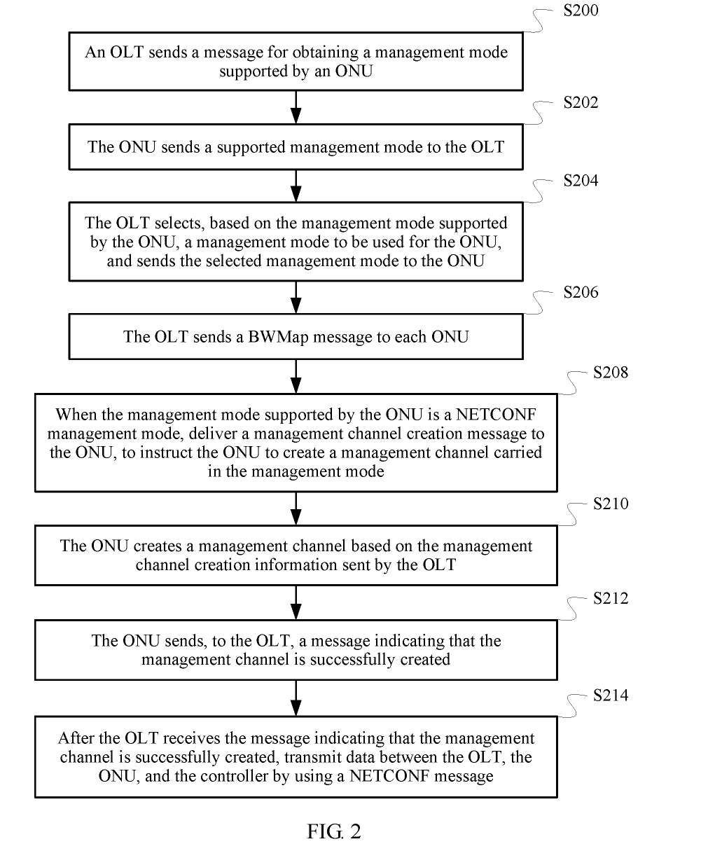

FIG. 2 is a method for managing an ONU. The method is applied to the system architecture in FIG. 1.

The method includes the following operations.

Operation S200. An OLT sends a message for obtaining a management mode supported by an ONU, where the management mode supported by the ONU includes one or more of an optical network unit management and control interface (OMCI) mode, an operation, administration, and maintenance (OAM) management mode, a network configuration protocol NETCONF management mode, a technical report 069 (TR069) management mode, and a simple network management (SNMP) management mode.

Specifically, all messages related to negotiation performed between the OLT and the ONU based on the management mode supported by the ONU may be implemented by using a message such as a physical layer OAM operation, administration, and maintenance (PLOAM) message or a multi-point control protocol (MPCP) message.

The negotiation based on the management mode of the ONU may be applied to a registration phase of the ONU. For a GPON system, a negotiation process based on the management mode of the ONU may be implemented by using an extended PLOAM message; for an EPON system, the negotiation process is implemented by using an extended MPCP message. The foregoing PLOAM message may be further applied to an XGPON and a TWDM PON, and the foregoing MPCP message may be further applied to a 10G-EPON and a 100G-EPON. All the following related messages may be implemented by the foregoing mentioned extended messages, or may be other messages.

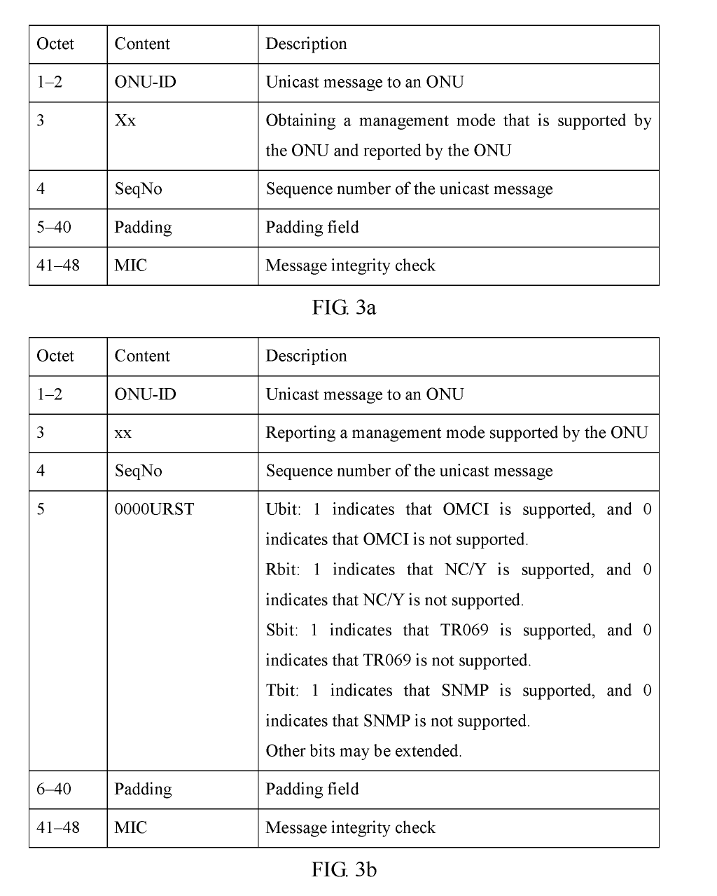

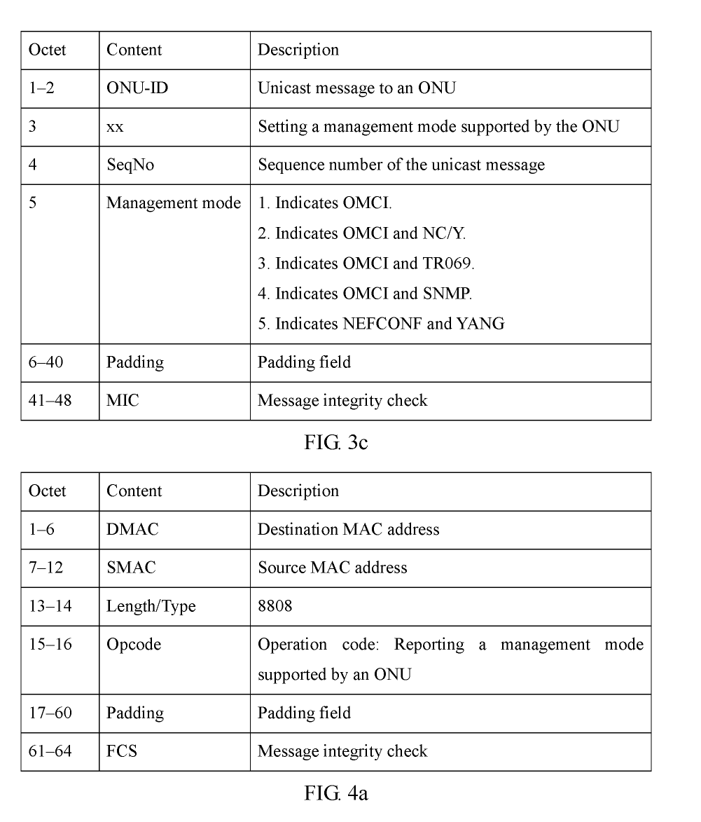

As shown in FIG. 3a, a format of an XG-PON/XGS/NG-PON2-extended PLOAM message is as follows:

Octets 1-2 are an “optical network unit (ONU)-identifier ID”, octet 3 is used to add a message type, and the message type is “a type of a message for obtaining a management mode supported by the ONU”, octet 4 is a sequence number (SN) and used to identify a sequence number of a unicast message, octets 5-40 are used to pad any content and may extend any content, and octets 41-48 are used to perform message integrity check MIC. In the format of the PLOAM message, a new message type is added, and other fields are consistent with those defined in an existing standard. For details, refer to meanings of all fields in a PLOAM message defined in the standard. A quantity of octets occupied by each field may be randomly adjusted and is not limited herein. A specific PLOAM message is not described herein.

The PLOAM message in FIG. 3a may be used in operation S200: The OLT sends the PLOAM message in FIG. 3a to the ONU, to obtain a management mode supported by the ONU.

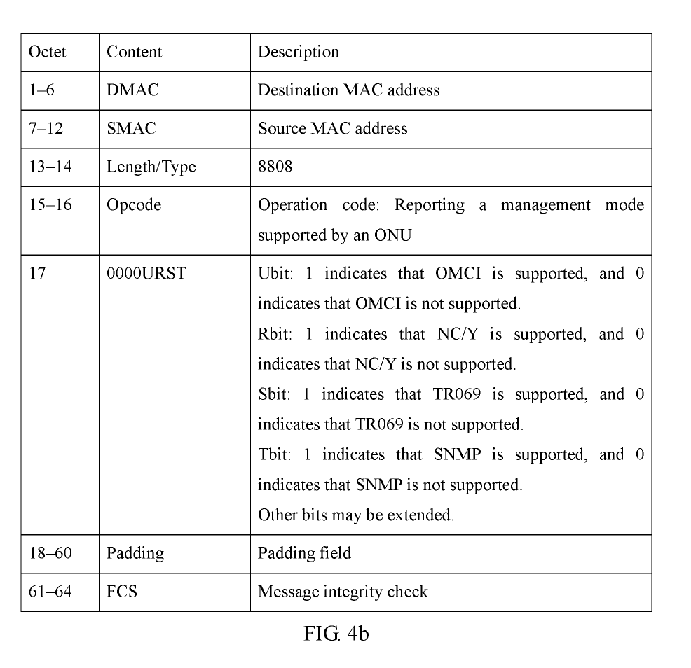

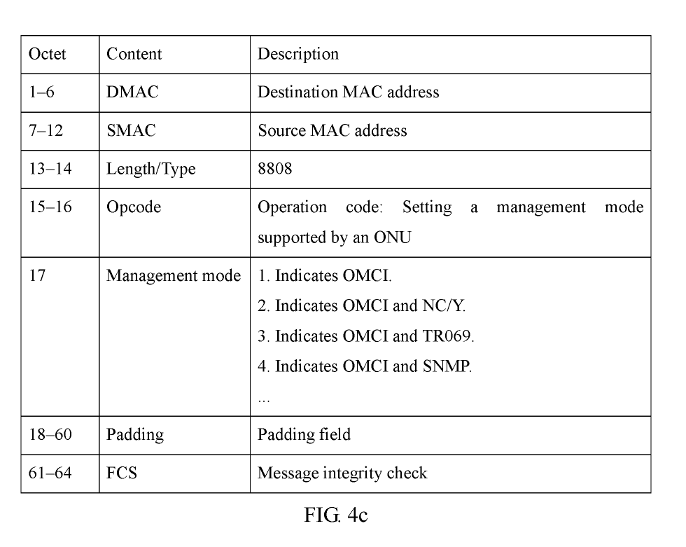

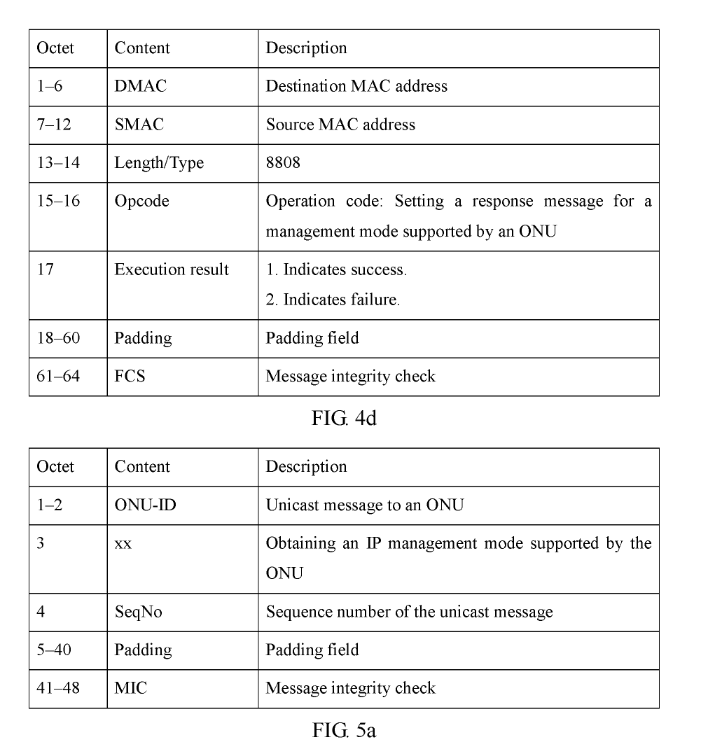

The foregoing negotiation related message may alternatively be indicated by a format of an extended MPCP message in FIG. 4a. Details are as follows:

Octets 1-6 are destination MAC (DMAC) used to indicate a destination MAC address of the message;

octets 7-12 are source MAC (SMAC) used to indicate a source MAC address of the message;

octets 13-14 are length/type used to indicate a length and a type of the message;

octets 15-16 are an operation code (Opcode) used to indicate an operation code for the message, and herein, a new operation code for “reporting a management mode supported by the ONU” is added; and

octets 17-60 are padding used to pad other content of the message.

For detailed descriptions of other fields, refer to a format of the MPCP message specified in a standard.

Certainly, the foregoing message is not limited to the extended PLOAM or MPCP message shown in the figures, provided that the message can implement the foregoing function.

Operation S202. The ONU sends a supported management mode to the OLT.

For a message sent by the ONU to report the management mode supported by the ONU, refer to FIG. 3b or FIG. 4b.

FIG. 3b shows an extended PLOAM message:

Octets 1-2 are an ONU identifier used to indicate a unicast message mode of the ONU;

octet 3 is an extended message type, and the message type is used to identify “a management mode that is supported by the ONU and reported by the ONU”;

octet 4 is a sequence number used to indicate a sequence number of a unicast message; and

octet 5 is a specific management mode reported by the ONU, one or more of OMCI, NETCONF.YANG (NC/Y), TR069, SNMP, or other management modes are supported, where a value 1 indicates that all the foregoing types are supported, and a value 0 indicates that none of the foregoing types are supported.

Definitions of other fields are consistent with those in a standard. Refer to meanings of the fields in the standard.

FIG. 4b shows an extended MPCP message:

Octets 1-6 are destination MAC (DMAC) used to indicate a destination MAC address of the message;

octets 7-12 are source MAC (SMAC) used to indicate a source MAC address of the message;

octets 13-14 are length/type used to indicate a length and a type of the message;

octets 15-16 are an operation code (Opcode) used to indicate an operation code for the message, and herein, a new operation code for “reporting a management mode supported by the ONU” is added;

octet 17 is used to indicate the management mode supported by the ONU, and specifically, one or more of OMCI, NETCONF.YONG (NC/Y), TR069, SNMP, or other types are supported, where 1 indicates that all the foregoing types are supported, and a value 0 indicates that none of the foregoing types are supported; and

octets 18-60 are padding used to pad other content of the message.

For detailed descriptions of other fields, refer to a format of the MPCP message specified in a standard.

Operation S204. The OLT selects, based on the management mode supported by the ONU, a management mode to be used for the ONU, and sends the selected management mode to the ONU.

After selecting a proper management mode for the ONU based on the management mode supported and reported by the ONU, the OLT interacts with the ONU by using an extended PLOAM message shown in FIG. 3c or an extended MPCP message shown in FIG. 4c.

As shown in FIG. 3c, a format of the extended PLOAM message is as follows:

Octets 1-2 are an ONU identifier used to indicate a unicast message mode of the ONU;

octet 3 is an extended message type, and the message type is used to identify “a management mode that is supported by the ONU and reported by the ONU”;

octet 4 is a sequence number used to indicate a sequence number of a unicast message; and

octet 5 is a management mode used to indicate a proper ONU management mode selected by the OLT for the ONU, and specifically, one or more of OMCI, NETCONF.YONG (NC/Y), TR069, SNMP, or other types are supported, where 1 indicates that OMCI is supported, 2 indicates that OMCI and NC/Y are supported, 3 indicates that OMCI and TR069 are supported, 4 indicates that OMCI and SNMP are supported, another value may be further used to indicate that SNMP, NC/Y, or TR069, or one or a combination of a plurality of the foregoing modes is supported, and a value 0 indicates that none of the foregoing types are supported.

Definitions of other fields are consistent with those in a standard. Refer to meanings of the fields in the standard.

FIG. 4c shows an extended MPCP message:

Octets 1-6 are destination MAC (DMAC) used to indicate a destination MAC address of the message;

octets 7-12 are source MAC (SMAC) used to indicate a source MAC address of the message;

octets 13-14 are length/type used to indicate a length and a type of the message;

octets 15-16 are an operation code (Opcode) used to indicate an operation code for the message, and herein, a new operation code for “setting a management mode supported by the ONU” is added;

octet 17 is used to indicate a proper ONU management mode selected by the OLT for the ONU, and specifically, one or more of OMCI, NETCONF.YONG (NC/Y), TR069, SNMP, or other types are supported, where 1 indicates that OMCI is supported, 2 indicates that OMCI and NC/Y are supported, 3 indicates that OMCI and TR069 are supported, 4 indicates that OMCI and SNMP are supported, another value may be further used to indicate that SNMP, NC/Y, or TR069, or one or a combination of a plurality of the foregoing modes is supported, and a value 0 indicates that none of the foregoing types are supported; and

octets 18-60 are padding used to pad other content of the message.

For detailed descriptions of other fields, refer to a format of the MPCP message specified in a standard.

Further, after receiving the management mode for the ONU that is delivered by the OLT, the ONU determines whether the ONU supports the management mode, and then replies to the OLT with a response message. For a specific format of the response message, an “execution result” may be added to an extended field or a preset field in an extended PLOAM message to indicate whether the ONU supports the management mode delivered by the OLT or does not support the management mode. Specifically, a value 1 may be used to indicate that the management mode is successfully supported, and a value 2 indicates failure, in other words, the management mode is not supported. The foregoing descriptions are not shown in a figure.

Alternatively, the foregoing response message may be reflected in a format of an MPCP message in FIG. 4d. Specific descriptions are as follows:

Octets 1-6 are used to indicate a destination MAC address of the message;

octets 7-12 are used to indicate a source MAC address of the message;

octets 13-14 are used to indicate a length and a type of the message;

octets 15-16 are used to indicate an operation code for the message, and herein, a new operation code for “setting a response message for a management mode supported by the ONU” is added; and

octet 17 is used to indicate an execution result, where a value 1 indicates that the ONU supports the management mode delivered by the OLT, and 2 indicates that the ONU does not support the management mode delivered by the OLT, in other words, the execution fails.

For detailed descriptions of other fields, refer to detailed descriptions of a format of the MPCP message specified in a standard. Details are not described herein.

Further, in one embodiment, the method may further include:

Operation S208. When the management mode supported by the ONU is the NETCONF management mode, the OLT deliver a management channel creation message to the ONU, to instruct the ONU to create a management channel to be used in the management mode.

A method for creating the management channel between the OLT and the ONU may be described below in detail:

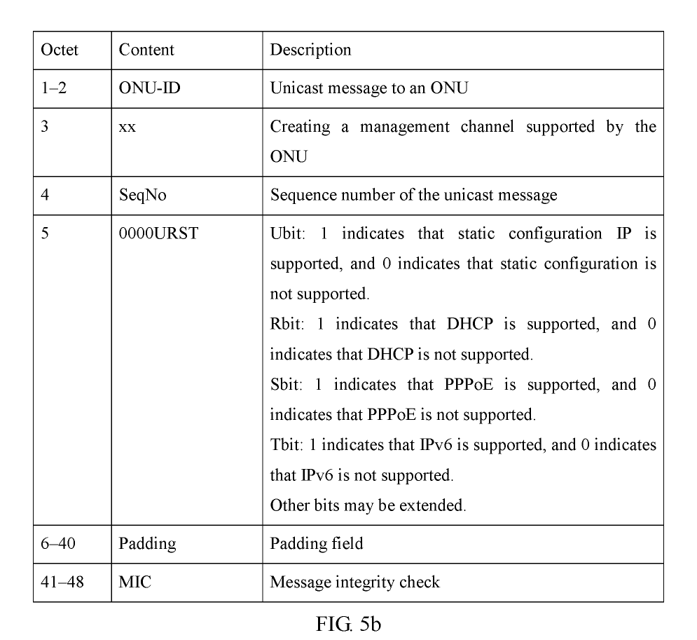

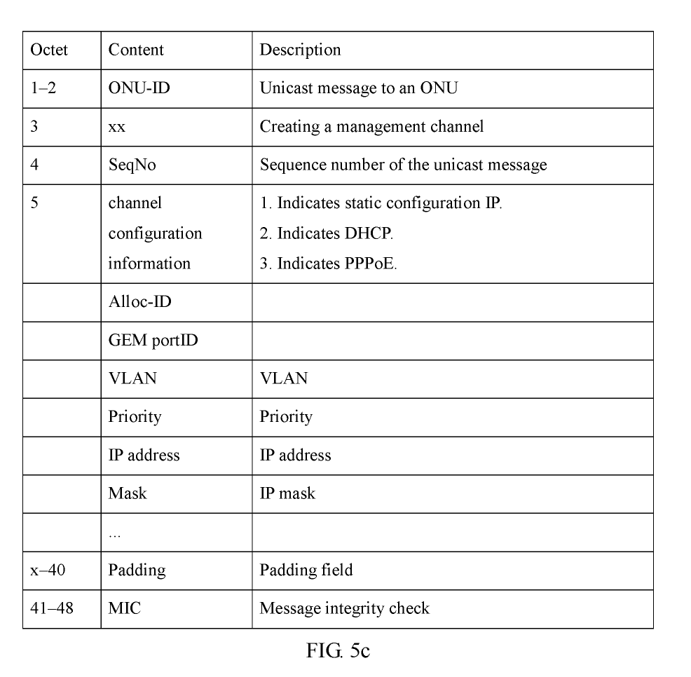

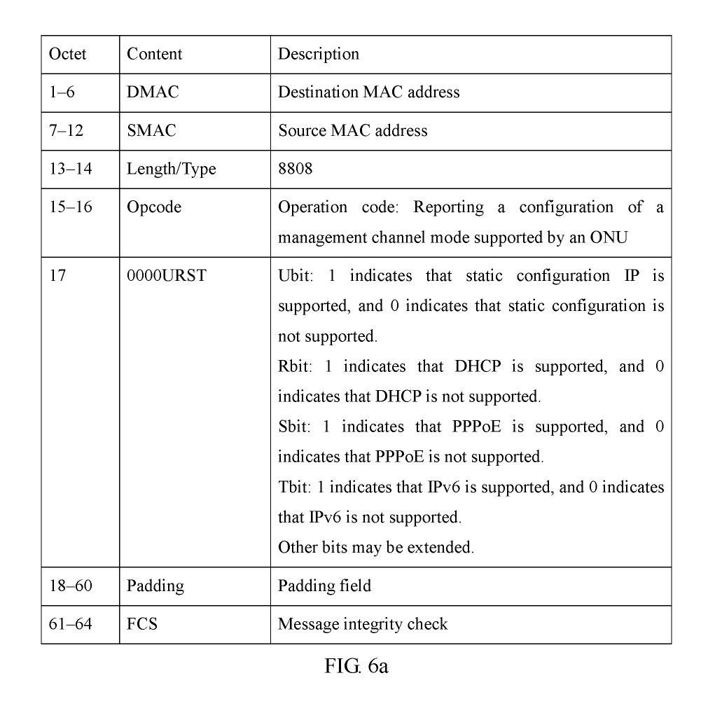

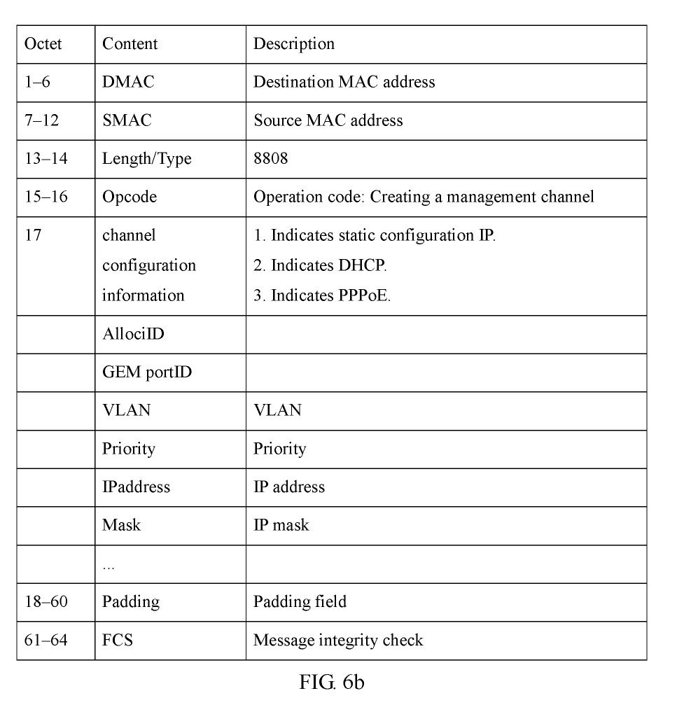

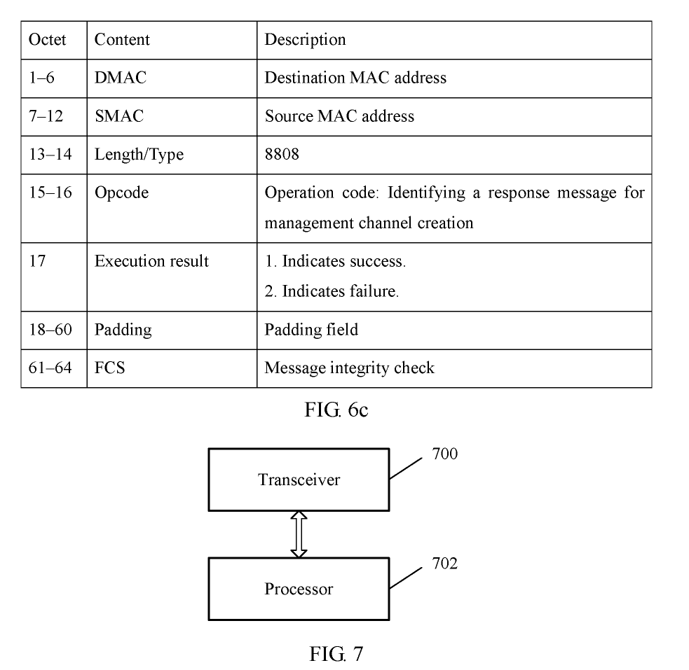

The OLT sends, to the ONU, a message for obtaining channel configuration information of the management channel supported by the ONU. The management channel may be an IP channel. The OLT may implement the foregoing function by using an extended PLOAM message in FIG. 5a or implement the foregoing function by using an extended MPCP message in FIG. 6a.

The ONU reports the channel configuration information to the OLT, where the channel configuration information includes one or more of a static configuration Internet protocol (IP), a dynamic host configuration protocol (DHCP), and a point-to-point protocol over Ethernet (PPPoE).

A specific format of a message that carries the channel configuration information and that is reported by the ONU to the OLT is shown in FIG. 5a or FIG. 6a.

As shown in FIG. 5a, octet 3 is used to add a type of message indicating a channel configuration mode supported by the ONU, and octet 5 is used to indicate the channel configuration mode supported by the ONU: one or a combination of a plurality of static configuration, DHCP, PPPoE, IPv6, and the like. A value 1 indicates that one or more of the foregoing configuration modes are supported, and a value 0 indicates that the channel configuration mode is not supported, where the values may be selected randomly. A quantity of octets occupied by each field in a related message and a manner of using a value to indicate whether the configuration is supported are not limited in this specification.

In one embodiment, the channel configuration information may further include information such as a default route and a gateway.

As shown in FIG. 6a, an operation code for an operation of “reporting a management channel configuration mode supported by the ONU” and the specific supported configuration mode are added. For details, refer to FIG. 6a.

The OLT selects, based on the channel configuration information returned by the ONU, a channel configuration used by the ONU, and delivers management channel creation message to the ONU, to instruct the ONU to create the management channel to be used in the management mode, where the management channel creation message includes management configuration information of the ONU and the channel configuration that is used by the ONU and determined by the OLT.

Specifically, the management configuration information includes information such as an allocation identifier (ALLOC-ID), a transport container (TCONT), a GEM frame port identifier (GEMPORT ID), a virtual local area network identifier (VLAN ID), and a priority.

Further, the OLT delivers the channel configuration information reported by the ONU and the management configuration information to the ONU, to instruct the ONU to create the management channel, for example, an IP channel based on the foregoing information.

For a specific message format, refer to FIG. 5b or FIG. 6b. Specifically, in FIG. 5b, octets are extended, to be specific, octet 3 is used to add a type of message for creating a management channel, and octet 5 is used to add management configuration information such as an Alloc-ID, and a specific supported management mode: one or a combination of a plurality of the following modes: 1. static configuration; 2. DHCP configuration; 3. PPPoE; and the like. A specific octet is not shown in the figure. Octets may be sequentially divided.

In FIG. 6b, octets 15-16 are used to add an operation code for “creating a management channel”, octet 17 is used to add the channel configuration information, and management configuration information is sequentially padded as shown above after octet 17. For details, refer to FIG. 6b.

Operation S210. The ONU creates a management channel based on the management channel creation message sent by the OLT.

Operation S212. The ONU sends, to the OLT, a message indicating that the management channel is successfully created.

For a specific format of the message indicating that the creation is successful, refer to an extended PLOAM message in FIG. 5c and an extended MPCP message in FIG. 6c.

It should be noted that in FIG. 6c, a “response message for management channel creation” and an “execution result” are extended to identify a message indicating whether the management channel is successfully created.

Operation S214. After the OLT receives the message indicating that the management channel is successfully created, transmit data between the OLT, the ONU, and the controller by using a NECONF message.

When the ONU supports a network configuration protocol (NETCONF), the OLT creates a management channel for the ONU by using an extended PLOAM message, for example, creates an Internet protocol (IP) management channel. After the management channel is created, data from the ONU is encapsulated into a format of a NETCONF message between the OLT and the ONU, and is transmitted on the created IP management channel, and the OLT sends the NETCONF message to the controller; or the OLT receives a NETCONF message from the controller, and forwards the NETCONF message to the ONU on the IP channel created between the OLT and the ONU.

According to the method for managing an ONU that is provided in this embodiment of the present disclosure, the ONU reports its supported management mode, and the OLT selects, based on the management mode supported by the ONU, the management mode to be used for the ONU, and sends the management mode to the ONU. In the method, the management mode of the ONU is negotiated between the OLT and the ONU. In this way, an existing system can support a plurality of management mechanisms of the ONU, management of the ONU is simplified, and efficiency of managing the ONU is improved.

An embodiment of the present disclosure further provides a network device. For a location of the network device in a PON system architecture, refer to the controller in FIG. 1. The network device may be integrated into an OLT or be independent of an OLT, and serve as a controller. A transceiver 700 may be the receiver and transmitter optical subassembly 200 in the OLT 110 in the system architecture, or the transceiver 700 is located in the receiver and transmitter optical subassembly 200 in the OLT 110 in the system architecture.

The transceiver 700 is configured to: send a message for obtaining a management mode supported by an optical network unit (ONU), where the management mode supported by the ONU includes one or more of an OMCI mode, an OAM management mode, a NETCONF management mode, a TR069 management mode, and a SNMP management mode; receive a management mode sent by the ONU; and send the selected management mode to the ONU.

A processor 702 is configured to: select a management mode for the ONU based on the management mode supported by the ONU; and send the selected management mode to the ONU by using the transceiver 700.

For interaction between the network device in the disclosure, the OLT, and the ONU, refer to descriptions of FIG. 2 to FIG. 6 and corresponding method embodiments. Details are not described herein again.

Further, the processor 702 is further configured to:

when the management mode supported by the ONU is the NETCONF management mode, instruct the transceiver to send a management channel creation message to the ONU, to instruct the ONU to create a management channel to be used in the management mode.

Further, the processor is specifically configured to: instruct the transceiver to send, to the ONU, a message for obtaining channel configuration information of the management channel supported by the ONU; select, based on the channel configuration information that is supported by the ONU and received by the transceiver, a channel configuration used by the ONU; and deliver management channel creation message to the ONU, to instruct the ONU to create, based on the management channel creation message, the management channel to be used in the management mode, where the management channel creation message includes management configuration information of the ONU and the channel configuration that is used by the ONU and determined by an OLT; and

the transceiver is configured to: send, to the ONU as instructed by the processor, the message for obtaining the channel configuration information of the management channel supported by the ONU, and receive the channel configuration information returned by the ONU, where the channel configuration information includes one or more of a static configuration IP, a DHCP, and a PPPoE.

Further, the transceiver is further configured to receive a management channel creation complete message returned by the ONU; and the processor is further configured to exchange data with the ONU on the created management channel in the NETCONF management mode.

According to a method for managing an ONU that is provided in this embodiment of the present disclosure, the ONU reports its supported management mode, and the OLT selects, based on the management mode supported by the ONU, the management mode to be used for the ONU, and sends the management mode to the ONU. In the method, the management mode of the ONU is negotiated between the OLT and the ONU. In this way, an existing system can support a plurality of management mechanisms of the ONU, management of the ONU is simplified, and efficiency of managing the ONU is improved.

With reference to FIG. 7 and the system architecture diagram in FIG. 1, the optical line terminal in FIG. 1 further includes the network device in FIG. 7. The network device is not shown in FIG. 1, in other words, the network device is integrated into the OLT. For a specific function performed by the network device, refer to the description in the foregoing embodiments.

The processor 702 in the figure may be a media access controller (MAC) or another microprocessor.

According to a method for managing an ONU that is provided in this embodiment of the present disclosure, the ONU reports its supported management mode, and the OLT selects, based on the management mode supported by the ONU, the management mode to be used for the ONU, and sends the management mode to the ONU. In the method, the management mode of the ONU is negotiated between the OLT and the ONU. In this way, an existing system can support a plurality of management mechanisms of the ONU, management of the ONU is simplified, and efficiency of managing the ONU is improved.

A passive optical network (PON) system shown in FIG. 1 includes an optical line terminal (OLT) and an optical network unit (ONU). The OLT is connected to the ONU by using an optical distribution network (ODN). For a structure of the OLT 110, refer to the description of the specific structure of the OLT. For a structure of the ONU, refer to the description of the specific structure of the ONU. For functions respectively performed by the OLT and the ONU, refer to the descriptions of the foregoing embodiments. Details are not described herein again.

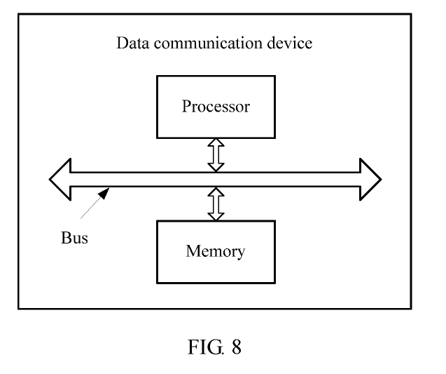

An embodiment of the present disclosure further provides a data communication device. As shown in FIG. 8, the data communication device includes a processor, a memory, and a bus system. The processor and the memory are connected by using the bus system. The memory is configured to store an instruction. The processor is configured to execute the instruction stored in the memory.

When the data communication device is an OLT, the processor is configured to: send a message for obtaining a management mode supported by an ONU, where the management mode supported by the ONU includes one or more of an OMCI mode, an OAM management mode, a NETCONF management mode, a TR069 management mode, and a SNMP management mode; receive a management mode sent by the ONU; and select, based on the management mode supported by the ONU, a management mode to be used for the ONU, and send the selected management mode to the ONU.

According to a method for managing an ONU that is provided in this embodiment of the present disclosure, the ONU reports its supported management mode, and the OLT selects, based on the management mode supported by the ONU, the management mode to be used for the ONU, and sends the management mode to the ONU. In the method, the management mode of the ONU is negotiated between the OLT and the ONU. In this way, an existing system can support a plurality of management mechanisms of the ONU, management of the ONU is simplified, and efficiency of managing the ONU is improved.

A person of ordinary skill in the art may understand that all or some of the operations of the embodiments may be implemented by hardware or a program instructing related hardware. The program may be stored in a computer-readable storage medium. The storage medium may include: a read-only memory, a magnetic disk, or an optical disc.

The foregoing descriptions are merely specific embodiments of the disclosure, but are not intended to limit the disclosure. Any modification, equivalent replacement, or improvement made without departing from the spirit and principle of the disclosure should fall within the protection scope of the disclosure.

1. A method for managing an optical network unit (ONU), comprising:
sending a message to the ONU, to obtain a management mode supported by the ONU;
receiving the management mode supported by the ONU, wherein the management mode supported by the ONU comprises one or more of an optical network unit management and control interface (OMCI) mode, an operation, administration, and maintenance (OAM) management mode, a network configuration protocol (NETCONF) management mode, a technical report 069 (TR069) management mode, or a simple network management protocol (SNMP) management mode; and
selecting, based on the management mode supported by the ONU, a management mode to be used for the ONU, and sending the selected management mode to be used for the ONU to the ONU.

2. The method for managing an ONU according to claim 1, further comprising:
when the management mode supported by the ONU is the NETCONF management mode, delivering a management channel creation message to the ONU, to instruct the ONU to create a management channel to be used in the management mode.

3. The method for managing an ONU according to claim 2, wherein the delivering a management channel creation message to the ONU, to instruct the ONU to create a management channel to be used in the management mode specifically comprises:
sending, to the ONU, a message for obtaining channel configuration information of the management channel supported by the ONU;
receiving a message that carries the channel configuration information and that is returned by the ONU, wherein the channel configuration information comprises information about one or more of a static configuration Internet protocol (IP), a dynamic host configuration protocol (DHCP), or a point-to-point protocol over Ethernet (PPPoE); and
selecting, based on the message that carries the channel configuration information and that is returned by the ONU, a channel configuration used by the ONU, and delivering the management channel creation message to the ONU, to instruct the ONU to create the management channel to be used in the management mode, wherein the management channel creation message comprises management configuration information of the ONU and the channel configuration that is used by the ONU and determined by an OLT.

4. The method for managing an ONU according to claim 2, further comprising:
receiving a management channel creation complete message returned by the ONU; and
exchanging data with the ONU in the NETCONF management mode.

5. A network device, comprising:
a transceiver, configured to send a message for obtaining a management mode supported by an optical network unit ONU); and receive a management mode sent by the ONU; and send the selected management mode to the ONU; and
a processor, configured to: select a management mode for the ONU based on the management mode supported by the ONU; send the selected management mode to the ONU by using the transceiver, wherein the management mode supported by the ONU comprises one or more of an optical network unit management and control interface (OMCI) mode, an operation, administration, and maintenance (OAM) management mode, a network configuration protocol (NETCONF) management mode, a technical report 069 (TR069) management mode, or a simple network management (SNMP) management mode.

6. The network device according to claim 5, wherein the processor is further configured to:
when the management mode supported by the ONU is the NETCONF management mode, instruct the transceiver to send a management channel creation message to the ONU, to instruct the ONU to create a management channel to be used in the management mode.

7. The network device according to claim 6, wherein
the processor is specifically configured to: instruct the transceiver to send, to the ONU, a message for obtaining channel configuration information of the management channel supported by the ONU; select, based on the channel configuration information received by the transceiver, a channel configuration used by the ONU; and a deliver management channel creation message to the ONU, to instruct the ONU to create, based on the management channel creation message, the management channel to be used in the management mode, wherein the management channel creation message comprises management configuration information of the ONU and the channel configuration that is used by the ONU and determined by an OLT; and
the transceiver is configured to: send, to the ONU as instructed by the processor, the message for obtaining the channel configuration information of the management channel supported by the ONU, and receive the channel configuration information returned by the ONU, wherein the channel configuration information comprises information about one or more of a static configuration Internet protocol (IP), a dynamic host configuration protocol (DHCP), or a point-to-point protocol over Ethernet (PPPoE).

8. The network device according to claim 5, wherein
the transceiver is further configured to receive a management channel creation complete message returned by the ONU; and
the processor is further configured to exchange data with the ONU on the created management channel in the NETCONF management mode.

9. The network device according to claim 5, wherein the network device is an optical line terminal (OLT).

10. A passive optical network (PON) system, comprising:
an optical line terminal (OLT) and an optical network unit (ONU), wherein the OLT is connected to the ONU by using an optical distribution network (ODN), and the OLT comprises:
a transceiver, configured to send a message for obtaining a management mode supported by an optical network unit (ONU); and receive a management mode sent by the ONU; and send the selected management mode to the ONU; and
a processor, configured to: select a management mode for the ONU based on the management mode supported by the ONU; send the selected management mode to the ONU by using the transceiver, wherein the management mode supported by the ONU comprises one or more of an optical network unit management and control interface (OMCI) mode, an operation, administration, and maintenance (OAM) management mode, a network configuration protocol (NETCONF) management mode, a technical report 069 (TR069) management mode, or a simple network management (SNMP) management mode.

11. The PON system according to claim 10, wherein the processor is further configured to:
when the management mode supported by the ONU is the NETCONF management mode, instruct the transceiver to send a management channel creation message to the ONU, to instruct the ONU to create a management channel to be used in the management mode.

12. The PON system according to claim 11, wherein
the processor is specifically configured to: instruct the transceiver to send, to the ONU, a message for obtaining channel configuration information of the management channel supported by the ONU; select, based on the channel configuration information received by the transceiver, a channel configuration used by the ONU; and a deliver management channel creation message to the ONU, to instruct the ONU to create, based on the management channel creation message, the management channel to be used in the management mode, wherein the management channel creation message comprises management configuration information of the ONU and the channel configuration that is used by the ONU and determined by an OLT; and
the transceiver is configured to: send, to the ONU as instructed by the processor, the message for obtaining the channel configuration information of the management channel supported by the ONU, and receive the channel configuration information returned by the ONU, wherein the channel configuration information comprises information about one or more of a static configuration Internet protocol (IP), a dynamic host configuration protocol (DHCP), or a point-to-point protocol over Ethernet (PPPoE).

13. The PON system according to claim 10, wherein
the transceiver is further configured to receive a management channel creation complete message returned by the ONU; and
the processor is further configured to exchange data with the ONU on the created management channel in the NETCONF management mode.
